(19) United States
(12) Patent Application Publication
(10) Pub. No.: US 2017/0135378 A1
(43) Pub. Date: May 18, 2017

(54) COMPOSITION AND USE THEREOF

(71) Applicant: DUPONT NUTRITION BIOSCIENCES APS, Copenhagen K (DK)

(72) Inventors: Kathryn Louise Tse, Valby (DK); Stephane Frouel, Paris (FR); Ajay Awati, Swindon (GB)

(21) Appl. No.: 15/320,276

(22) PCT Filed: Jun. 24, 2015
(86) PCT No.: PCT/EP2015/064294

§ 371 Date: Dec. 19, 2016

(30) Foreign Application Priority Data
Jun. 24, 2014 (GB) 1411196.7

(51) Int. Cl. A23K 50/80; A23K 20/147; A23K 20/158; A23K 40/30; A23K 20/174; A23K 20/189; A23K 20/20; A23K 20/142; A23K 20/163

(52) U.S. Cl. CPC A23K 50/80; A23K 20/142; A23K 20/147; A23K 20/158; A23K 20/163; A23K 20/174; A23K 20/189; A23K 20/20; A23K 40/30

(57) ABSTRACT

The present invention relates to a composition comprising a hydro-soluble component and a coating substance, wherein the hydro-soluble component is coated with the coating substance, wherein the coating substance reduces leaching of the hydro-soluble component from the composition when the composition is contacted with aqueous media. Furthermore, the present invention relates to uses of said composition and an aquafeed comprising said composition.

### FIELD OF THE INVENTION

The present invention relates to a composition and its use in aquaculture.

In particular, the present invention relates to a composition for reducing the leaching of a hydro-soluble component into aqueous media. Furthermore, the present invention relates to a composition which is advantageous as a component of an aquafeed.

### BACKGROUND OF THE INVENTION

Aquaculture is the fastest growing sector of food production in the world. The Food and Agriculture Organization (“FAO”) of the United Nations reports that aquaculture accounts for almost 50% of the world's food fish. Aquaculture has the greatest potential to meet the growing demand for aquatic food that will arise from an expected population increase of 1.5 billion people in 2020.

In order to maintain the current per capita consumption, an additional 40 million tons of aquatic food will be required by 2030. Mounting scientific evidence indicates that dramatic declines in many natural fish stocks are occurring. Capture fisheries are not capable of providing fish to an additional 1.5 billion people, considering that the FAO already lists 89% of the ocean's wild fish stocks as moderately, fully or over-exploited.

In addition to meeting global consumption needs, aquaculture, particularly shrimp farming, has become an increasingly important economic activity. In recent years, market demand from mainly affluent consumers in developed countries has led to rapid expansion of shrimp aquaculture throughout Asia and Latin America. In 1999, shrimp aquaculture only represented about 2.6% of total global aquaculture, but accounted for 16.5% of the total revenue at a value of about $6.7 billion. Considerable private and public sector investment has induced an annual average increase in cultured shrimp production of about 5-10% since the 1990′s.

Shrimp farming is one of the most profitable and fastest-growing segments of the aquaculture industry. Global farmed shrimp production has grown more than 100-fold (by weight) in less than two decades; from under 10,000 metric tons produced by fewer than a dozen countries in the early 1970s to over 1 million MT by the late 1990s. Worldwide sale of shrimp is estimated to be a 10 billion dollar industry. In 2006, aquafeeds used 68 percent of the world's supply of fish meal (3.724 million metric tons) and 88.5 percent of fish oil (835,000 million metric tons). Aquafeed production is expected to double within 10 years.

It is a challenge to use hydro-soluble components (such as hydro-soluble feeds or hydro-soluble feed additives) in aquaculture nutrition as these hydro-soluble components leach into the aqueous environment. This may result in degradation of the hydro-soluble component, environmental damage and/or increased cost of production of the aquafeed as larger amounts of the component are required in order to ensure that they achieve the requisite function.

There is a need in the art for the provision of an aquafeed comprising hydro-soluble components which addresses one or more of the above problems.

### SUMMARY OF INVENTION

In a first aspect, the present invention relates to a composition comprising a hydro-soluble component and a coating substance, wherein the hydro-soluble component is coated with the coating substance, wherein the coating substance reduces leaching of the hydro-soluble component from the composition when the composition is contacted with aqueous media.

In a second aspect, the present invention relates to the use of a composition comprising a hydro-soluble component and a coating substance, wherein the hydro-soluble component is coated with the coating substance, for reducing leaching of a hydro-soluble component from a composition when said composition is contacted with aqueous media.

In a third aspect, the present invention relates to the use of a coating substance for reducing leaching of a hydro-soluble component from a composition when said composition is contacted with aqueous media.

In a fourth aspect, the present invention relates to a method for reducing leaching of a hydro-soluble component from a composition when said composition is contacted with aqueous media, said method comprising coating a hydro-soluble component with a coating substance, wherein said coating substance reduces leaching of the hydro-soluble component from the composition when the composition is contacted with aqueous media.

In a fifth aspect, the present invention relates to a process for the preparation of a composition as described herein, said process comprising coating a hydro-soluble component with a coating substance.

In a sixth aspect, the present invention relates to the use or a method as described herein wherein the hydro-soluble component is betaine.

In a seventh aspect, the present invention relates to a composition comprising a hydro-soluble component coated with a coating substance wherein the coating substance comprises microlayers of a hardened fat.

In a eighth aspect, the present invention relates to a composition comprising a coated hydro-soluble component obtainable by a process comprising hot melt coating a hydro-soluble component with a hardened fat.

In a ninth aspect, the present invention relates to a composition comprising a hydro-soluble component coated with a coating substance wherein the hydro-soluble component and coating substance form a core of the composition, and wherein the core is coated with a further coating substance.

In a tenth aspect, the present invention relates to an aquafeed comprising a composition as defined herein.

### BRIEF DESCRIPTION OF FIGURES

FIG. 1 represents leach profiles from shrimp feed pellets comprising coated betaine, prepared with c. 2 kg betaine/T.

FIG. 2 represents leach profiles from shrimp feed pellets comprising coated betaine, prepared with c. 5 kg betaine/T.

FIG. 3 represents leach profiles from shrimp feed pellets comprising coated betaine, prepared with c. 10 kg betaine/T.

FIG. 4 represents leach profiles coated betaine samples, with a payload of 60%.

FIG. 5 represents leach profiles coated betaine samples with a payload of 85%.

### DETAILED DESCRIPTION OF THE INVENTION

In a one aspect, the present invention relates to a composition comprising a hydro-soluble component and a coating substance, wherein the hydro-soluble component is coated with the coating substance, wherein the coating substance reduces leaching of the hydro-soluble component from the composition when the composition is contacted with aqueous media.

In another aspect, the present invention relates to the use of a composition comprising a hydro-soluble component and a coating substance, wherein the hydro-soluble component is coated with the coating substance, for reducing leaching of a hydro-soluble component from a composition when said composition is contacted with aqueous media.

In another aspect, the present invention relates to the use of a coating substance for reducing leaching of a hydro-soluble component from a composition when said composition is contacted with aqueous media.

In another aspect, the present invention relates to a method for reducing leaching of a hydro-soluble component from a composition when said composition is contacted with aqueous media, said method comprising coating a hydro-soluble component with a coating substance, wherein said coating substance reduces leaching of the hydro-soluble component from the composition when the composition is contacted with aqueous media.

In one embodiment, “reduces the leaching of hydro-soluble component” or “reducing the leaching of the hydro-soluble component” refers to reducing the extent of release of the hydro-soluble component from the composition into aqueous media. In particular, reducing the amount of the hydro-soluble component released as a percentage of the total amount of hydro-soluble component in the composition.

In one embodiment, “reduces the leaching of the hydro-soluble component” or “reducing the leaching of the hydro-soluble component” refers to reducing the rate of release of the hydro-soluble component from the composition in aqueous media. In particular, reducing the amount of hydro-soluble component released as a percentage of the total amount of the hydro-soluble component in the composition in a period of time.

In one embodiment, “reduces the leaching of the hydro-soluble component” or “reducing the leaching of the hydro-soluble component” refers to reducing both the rate and extent of release of the hydro-soluble component from the composition in aqueous media.

In one embodiment, a reduction in leaching, the extent and/or rate of release of the feed or feed additive may be determined by the following method (herein referred to as “assay method”):

An aquafeed comprising the composition of the invention (or the composition itself) is placed in a rotating basket and immersed in 500 ml of artificial seawater (547.6 mM NaCl, 56.8 mM MgSO4.7H₂O, 2.4 mM NaHCO₃, adjusted to pH 8,2 with 1M NaOH), and held at 30° C. Aliquots of sample are withdrawn at selected time-points (1, 3, 5, 10, 15, 30, 45, 60 and 90 minutes). The volume of dissolution media is held constant through the re-addition of aliquots (30° C.) of fresh media to compensate. The aliquots are analysed by a suitable analytical technique (e.g. HPLC) in order to determine the concentration of the hydro-soluble component in the dissolution media.

The resultant data can be used to plot a concentration vs. time release profile. A reduction in leaching can be observed by performing a comparative study with an analogous sample containing uncoated hydro-soluble component and comparing the rate and/or extent of release of the hydro-soluble component into the aqueous media.

In one embodiment, the period of time as referred to above may be selected from 10, 20, 30, 40, 50, 60, 70, 80 and 90 minutes. Preferably, 90 minutes.

In one embodiment, the composition of the invention is present in the aquafeed in an amount of at least about 0.2% (w/w), or at least about 0.5% (w/w), or at least about 1% (w/w).

In another embodiment, the composition of the invention is present in the aquafeed in an amount of about 0.2% (w/w), or about 0.5% (w/w), or about 1% (w/w).

In one embodiment, leaching is reduced such that 50% (w/w) or less of the total hydro-soluble component present in the aquafeed composition is released into the aqueous media. Preferably, 45% (w/w) or less of the total hydro-soluble component present in the composition is released, more preferably 40% (w/w) or less of the total hydro-soluble component present in the composition is released, more preferably 35% (w/w) or less of the total hydro-soluble component present in the composition is released, more preferably 30% (w/w) or less of the hydro-soluble component present in the composition is released.

In one embodiment, leaching is reduced such that between 5 and 50% (w/w) of the total hydro-soluble component present in the aquafeed composition is released into the aqueous media. Preferably between 10 and 50% (w/w), more preferably between 20 and 50% (w/w), more preferably between 30 and 50% (w/w), more preferably between 20 and 40% (w/w), more preferably between 30 and 40% (w/w).

In one embodiment, leaching is reduced such that between 5 and 50% (w/w) of the total hydro-soluble component present in the aquafeed composition is released into the aqueous media in a period of time as defined above. Preferably between 10 and 50% (w/w), more preferably between 20 and 50% (w/w), more preferably between 30 and 50% (w/w), more preferably between 20 and 40% (w/w), more preferably between 20 and 30% (w/w).

In one embodiment, leaching is reduced such that between 5 and 50% (w/w) of the total hydro-soluble component present in the aquafeed composition is released into the aqueous media in a period of time of 90 minutes. Preferably between 10 and 50% (w/w), more preferably between 20 and 50% (w/w), more preferably between 30 and 50% (w/w), more preferably between 20 and 40% (w/w), more preferably between 20 and 30% (w/w).

In one embodiment, the aquafeed comprises the composition of the invention in an amount of at least about 0.2% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of at least about 0.2% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w), of the total hydro-soluble component present in the aquafeed composition is released into the aqueous media in a period of time of 90 minutes.

In one embodiment, the aquafeed comprises the composition of the invention in an amount of at least about 0.5% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of at least about 0.5% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w) of the total hydro-soluble component present in the aquafeed composition is released into the aqueous media in a period of time of 90 minutes.

In one embodiment, the aquafeed comprises the composition of the invention in an amount of at least about 1% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of at least about 1% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w) of the total hydro-soluble component present in the aquafeed composition is released into the aqueous media in a period of time of 90 minutes.

In one embodiment, the aquafeed comprises the composition of the invention in an amount of about 0.2% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of about 0.2% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w), of the total hydro-soluble component present in the aquafeed composition is released into the aqueous media in a period of time of 90 minutes.

In one embodiment, the aquafeed comprises the composition of the invention in an amount of about 0.5% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of about 0.5% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w) of the total hydro-soluble component present in the aquafeed composition is released into the aqueous media in a period of time of 90 minutes.

In one embodiment, the aquafeed comprises the composition of the invention in an amount of about 1% (w/w), and leaching is reduced such that between 5 and 50% (w/w) of the total hydro-soluble component present in the aquafeed composition is released into the aqueous media in a period of time of 90 minutes.

In one embodiment, the aquafeed comprises the composition of the invention in an amount of about 1% (w/w), and leaching is reduced such that between 10 and 50% (w/w), more preferably between 20 and 50% (w/w), more preferably between 30 and 50% (w/w), more preferably between 20 and 40% (w/w), more preferably between 20 and 30% (w/w) of the total hydro-soluble component present in the aquafeed composition is released into the aqueous media in a period of time of 90 minutes.

In one embodiment, each of the above described reductions in leaching may be determined by placing 30 g of a sample of the aquafeed comprising the composition of the invention in a rotating basket and immersing in 500 ml of artificial seawater (547.6 mM NaCl, 56.8 mM MgSO4.7H₂O, 2.4 mM NaHCO₃, adjusted to pH 8,2 with 1M NaOH) at 30° C.

In one embodiment, each of the above described reductions in leaching is determinable based on said assay method referred to above.

In one embodiment, leaching is reduced such that 80% (w/w) or less of the total hydro-soluble component present in the composition is released into the aqueous media. Preferably, 70% (w/w) or less of the total hydro-soluble component present in the composition is released, more preferably 60% (w/w) or less of the total hydro-soluble component present in the composition is released, more preferably 50% (w/w) or less of the total hydro-soluble component present in the composition is released, more preferably 40% (w/w) or less of the hydro-soluble component present in the composition is released.

In one embodiment, leaching is reduced such that between 10 and 80% (w/w) of the total hydro-soluble component present in the composition is released into the aqueous media in a period of time of 90 minutes. Preferably between 10 and 70% (w/w), more preferably between 10 and 60% (w/w), more preferably between 10 and 50% (w/w), more preferably between 10 and 40% (w/w), more preferably between 10 and 30% (w/w).

In one embodiment, leaching is reduced such that between 20 and 80% (w/w) of the total hydro-soluble component present in the composition is released into the aqueous media in a period of time of 90 minutes. Preferably between 20 and 70% (w/w), more preferably between 20 and 60% (w/w), more preferably between 20 and 50% (w/w), more preferably between 20 and 40% (w/w), more preferably between 20 and 30% (w/w).

In one embodiment, leaching is reduced such that between 30 and 80% (w/w) of the total hydro-soluble component present in the composition is released into the aqueous media in a period of time of 90 minutes. Preferably between 30 and 70% (w/w), more preferably between 30 and 60% (w/w), more preferably between 30 and 50% (w/w), more preferably between 30 and 40% (w/w).

In one embodiment, each of the above described reductions in leaching may be determined by placing a sample of the composition of the invention in a rotating basket and immersing in 500ml of artificial seawater (547.6 mM NaCl, 56.8 mM MgSO4.7H₂O, 2.4 mM NaHCO₃, adjusted to pH 8,2 with 1M NaOH) at 30° C.

In one embodiment, each of the above described reductions in leaching is determinable based on said assay method referred to above.

In one embodiment, the aqueous media referred to above is selected from sodium chloride solution, seawater, river water, pond water and water suitable for drinking. Preferably, the aqueous media is seawater or water suitable for drinking.

In one embodiment, the coating substances reduce leaching, preferably as described above, of the hydro-soluble component into the aqueous media when the composition is suspended in the aqueous media (preferably as described above).

In one embodiment, the coating substances reduce leaching, preferably as described above, of the hydro-soluble component when the composition is immersed in aqueous media (preferably as described above).

Hydro-Soluble Component

In one embodiment, the hydro-soluble component may be a hydro-soluble feed or a hydro-soluble feed additive.

As used herein the term ‘feed’ refers to a substance which provides nutritional value to aqualife, preferably fish (such as fish of the salmonid group, trout, salmon, whitefish such as tilapia, grouper, sea bass, catfish, tuna, carp and cod) or crustaceans (such as lobsters, crabs, shrimp, prawns and crayfish).

As used herein the term ‘feed additive’ refers to a substance which is added to a feed. Feed additives may be added to feed for a number of reasons. For instance, to enhance digestibility of the feed, to supplement the nutritional value of the feed, improve the ability of the recipient to cope with osmotic shock and/or to improve the shelf life of the feed.

Preferably, the feed additive supplements the nutritional value of the feed and/or improves the ability of the recipient to cope with osmotic shock.

In one embodiment, a feed additive may also be considered a feed.

In one embodiment, the hydro-soluble component comprises betaine or an aquatically acceptable salt or hydrate thereof.

In one embodiment, the hydro-soluble component essentially consists of betaine or an aquatically acceptable salt or hydrate thereof.

In one embodiment, the hydro-soluble component consists of betaine or an aquatically acceptable salt or hydrate thereof.

In one embodiment, the hydro-soluble feed or hydro-soluble feed additive is selected from betaine, direct fed microbials, essential oils, feed enzymes, organic acids, amino acids, vitamins and minerals.

As used herein the term “direct fed microbials” refers to a live microbial feed supplement which beneficially affects the host by improving its intestinal microbial balance.

In one embodiment, a direct fed microbial may utilize one or more types of bacteria, and/or yeast, and/or fungi. In one embodiment, the direct fed microbials comprise one or more types of bacteria. In one embodiment, the bacteria are selected from one or more of L. lactis, L. plantarum, L. casei, Bacillus subtilis, B. lichenformis, Enterococcus faecium, Bifidobacterium bifidum, B. longum, and B. thermophilum.

Feed enzymes may be selected from phytase feed enzymes, carbohydrase feed enzymes and protease feed enzymes and mixtures thereof.

Preferably, the hydrosoluble feed or feed additive is betaine, or an aquatically acceptable salt or hydrate thereof.

As used herein the term “betaine” refers to trimethylglycine. The compound is also called trimethylammonioacetate, 1-carboxy-N,N,N-trimethylmethaneaminium, inner salt and glycine betaine. It is a naturally occurring quaternary ammonium type compound having the formula

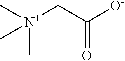

Betaine has a bipolar structure comprising a hydrophilic moiety (COO—) and a hydrophobic moiety (N⁺) capable of neutralizing both acid and alkaline solutions. In its pure form, betaine is a white crystalline compound that is readily soluble in water and lower alcohols. In the present invention betaine can be used, for example, as anhydrous form, or as a monohydrate or an aquatically acceptable salt.

Betaine is commercially available from Finnfeeds Finland Oy as an anhydrous form and also as a monohydrate.

As used herein an “aquatically acceptable salt” means any non-toxic salt that, upon administration to an aqualife, is capable of providing, either directly or indirectly, a compound or a derivative of a compound of this invention. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para- bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, di nitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred aquatically acceptable acid addition salts include those formed with mineral acids such as hydrochloric acid and hydrobromic acid, and those formed with organic acids such as maleic acid.

Suitable cations for forming feed acceptable salts include ammonium, sodium, potassium, calcium, magnesium and aluminium cations, among others.

In one embodiment, when betaine is present, it is present as the free zwitterion.

In one embodiment, when betaine is present, it is present as anhydrous betaine.

In one embodiment, when betaine is present, it is present as the monohydrate.

Coating substance

In one embodiment, the coating substance reduces leaching of the hydro-soluble component from the composition when the composition is contacted with aqueous media.

In one embodiment, the coating substance comprises a lipid, an emulsifier or a polymer. In another embodiment, the coating substance comprises a lipid or a polymer. In another embodiment, the coating substance comprises a lipid.

In one embodiment, the coating substance consists essentially of a lipid, an emulsifier or a polymer. In another embodiment, the coating substance consists essentially of a lipid or a polymer. In another embodiment, the coating substance consists essentially of a lipid.

In one embodiment, the coating substance consists of a lipid, an emulsifier or a polymer. In another embodiment, the coating substance consists of a lipid or a polymer. In another embodiment, the coating substance consists of a lipid.

In one embodiment, the emulsifier is selected from fatty acid monoglycerides, diglycerides, polyglycerol esters and sorbitan esters of fatty acids.

In one embodiment, the lipid is selected from animal oils or fats, vegetable oils or fats, triglycerides, free fatty acids, animal waxes, (such as beeswax, lanolin, shell wax or Chinese insect wax)., vegetable waxes (such as carnauba, candelilla, bayberry or sugarcane), mineral waxes, synthetic waxes, natural and synthetic resins and mixtures thereof.

In another embodiment, the lipid is selected from animal oils or fats, vegetable oils or fats, triglycerides, vegetable waxes (such as carnauba, candelilla, bayberry or sugarcane), mineral waxes, synthetic waxes, natural and synthetic resins and mixtures thereof.

In another embodiment, the lipid is selected from hardened vegetable oils or fats, triglycerides, and mixtures thereof.

Preferably the lipid is a fat, preferably a vegetable-derived fat.

Preferably the fat is solid at room temperature. More preferably the fat has a melting point of about 40° C. or more. More preferably the fat has a melting point of about 50° C. or more. More preferably the fat has a melting point of about 60° C. or more.

In one embodiment, the fat has a melting point of about 40° C. to about 80° C., preferably the fat has a melting point of about 50° C. to about 80° C., preferably the fat has a melting point of about 55° C. to about 75° C., preferably the fat has a melting point of about 55° C. to about 70° C.

Preferably the fat is a hardened fat, more preferably a fully hardened fat.

In another embodiment, the coating substance comprises a lipid selected from a hardened fat, more preferably a fully hardened fat.

The term “hardened fat” or “hydrogenated fat” is fat that has been exposed to a hydrogenation process (Ullmann's Encyclopaedia of Industrial Chemistry, Sixth Edition, Fats and Fatty Oils, 4.3 and 8). Typically, the fat is subjected to catalytic hydrogenation in the presence of a transition metal catalyst, for example, a nickel, palladium or platinum catalyst.

Fully hardened fat is defined as a fat having an Iodine Value (IV) of less than 5, where the iodine value is measured by the conventional IUPAC technique (International Union of Pure and Applied Chemistry (IUPAC), Standard Method for the Analysis of Oils, Fats and Derivatives, Method 2.205).

Preferably, the fats are free fatty acids (such as stearic acid, palmitic acid and oleic acid) or derivatives of fatty acids and glycerol. More preferably, the fats are comprised of triglycerides.

The term “triglyceride” preferably means a triester of glycerol and a fatty acid.

Preferably, the triglyceride is a triester of glycerol, and a C₄ to C₂₄ fatty acid.

More preferably, the triglyceride is selected from triglycerides having a fatty acid chain length of 10 carbons or more; more preferably, 14 carbons or more; or mixtures thereof.

Preferably, the triglyceride is selected from triglycerides having a fatty acid chain length of 10 to 20 carbons, more preferably 14 to 18 carbons; or mixtures thereof.

In a preferred embodiment, the fat comprises triglycerides having a C14, C16 and C18 fatty acid chain length, and mixtures thereof.

Preferably the fatty acid of the triglyceride is saturated.

In another embodiment, the coating substance comprises, essentially consists or consists of a fat selected from canola oil, cottonseed oil, peanut oil, corn oil, olive oil, soybean oil, sunflower oil, safflower oil, coconut oil, palm oil, linseed oil, tung oil, castor oil and rapeseed oil.

Preferably, the coating substance comprises, essentially consists or consists of a fat selected from hardened canola oil, hardened cottonseed oil, hardened peanut oil, hardened corn oil, hardened olive oil, hardened soybean oil, hardened sunflower oil, hardened safflower oil, hardened coconut oil, hardened palm oil, hardened linseed oil, hardened tung oil, hardened castor oil, and hardened rapeseed oil.

Preferably, the coating substance comprises, essentially consists or consists of a fat selected from fully hardened canola oil, hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil, and fully hardened rapeseed oil.

In another embodiment, the coating substance consists essentially of a fat selected from palm oil, rapeseed oil, cottonseed oil and soybean oil; preferably, hardened palm oil, hardened rapeseed oil, hardened cottonseed oil and hardened soybean oil; more preferably, fully hardened palm oil, fully hardened rapeseed oil, fully hardened cottonseed oil and fully hardened soybean oil.

In another embodiment, the coating substance comprises a polymer selected for one or more of film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In another embodiment, the coating substance comprises a polymer selected from water soluble polymers (such as polyvinylalcohol), or a film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In one embodiment, the coating substance comprises a polymer selected from one or more of ethylcellulose, hydroxyethylcellulose, hydroxypropylcellulose, carrageenan and sodium alginate.

In one embodiment, the coating substance comprises a polymer selected from one or more of ethylcellulose, hydroxyethylcellulose, hydroxypropylcellulose, polyvinylalcohol, carrageenan and sodium alginate.

In one embodiment, the polymer is feed grade polymer with a slow rate of aqueous solubility, for example, a polyvinylalcohol. The rate of solubility of polyvinylalcohol can be adjusted by changing the degree of hydrolysis or the molecular weight of the polymer. Increasing either will slow the rate of solubility in water.

Examples of polyvinylalcohols with a high degree of hydrolysis (e.g. fully hydrolysed) are Poval 4-98 (from Kuraray) and SELVOL E103 (from Seiksui). Examples of polyvinylalcohol grades with high molecular weight are Mowial 18-88 (from Kuraray) and SELVOL 107 (from Seiksui).

In one embodiment, the polymer is a fully hydrolysed polyvinylalcohol. In one embodiment, the fully hydrolysed polyvinylalcohol is greater than about 98% hydrolysed. In another embodiment, the fully hydrolysed polyvinylalcohol is about 98% to about 99% hydrolysed.

In one embodiment, the polymer is a high molecular weight polyvinylalcohol. In one embodiment, the number or mass average molecular weight is greater than about 100,000. In another embodiment, the number or mass average molecular weight is greater than about 110,000. In another embodiment, the number or mass average molecular weight is greater than about 120,000. In another embodiment, the number or mass average molecular weight is greater than about 130,000.

In one embodiment, the number or mass average molecular weight is about 100,000 to about 200,000. In one embodiment, the number or mass average molecular weight is about 110,000 to about 190,000. In one embodiment, the number or mass average molecular weight is about 120,000 to about 190,000. In one embodiment, the number or mass average molecular weight is about 130,000 to about 190,000. In one embodiment, the number or mass average molecular weight is about 130,000 to about 170,000. In one embodiment, the number or mass average molecular weight is about 130,000 to about 150,000.

In one embodiment the number or mass average weight is about 131,000.

In one embodiment, the polymer is high molecular weight and fully hydrolysed polyvinylalcohol. More specifically, the polymer is a high molecular weight and fully hydrolysed polyvinylalcohol as defined above,

In another embodiment, the coating substance comprises one or more of the following: ethylcellulose, HMPC, carageenan, sodium alginate, fully hardened palm oil, fully hardened rapeseed oil, fully hardened cottonseed oil and fully hardened soybean oil.

In another embodiment, the coating substance comprises one or more of the following: ethylcellulose, HMPC, polyvinylalcohol, carageenan, sodium alginate, fully hardened palm oil, fully hardened rapeseed oil, fully hardened cottonseed oil and fully hardened soybean oil. In another embodiment, the coating substance may further comprise other ingredients, such as inert fillers (e.g. calcium hydrogen phosphate).

In one embodiment, the hydro-soluble component is coated wherein the hydro-soluble component is encapsulated within a cross-linked aqueous hydrocolloid droplet which itself is encapsulated in a solid fat droplet.

In another embodiment, the hydro-soluble component is coated with microlayers of a lipid, preferably the lipid is as described above.

In another embodiment, the hydro-soluble component is coated wherein the hydro-soluble component is suspended as a dispersed phase within a polymer continuous phase, preferably the polymer is as described above.

In another embodiment, the hydro-soluble component is coated wherein hydro-soluble component and coating substance form a core, and the core is encapsulated with coating substance.

In another embodiment, the hydro-soluble component is coated wherein the hydro-soluble component is dispersed within a lipid (e.g. by spray-cooling), preferably the lipid is as described above. The resultant coated hydro-soluble component forms a core, which is then itself coated (e.g. by hot melt coating) with a layer of lipid to form an encapsulated core. Preferably, the lipid comprises a fat as defined above. More preferably, the lipid is fully hardened palm oil, fully hardened rapeseed oil, fully hardened cottonseed oil or fully hardened soybean oil.

In one embodiment, the hydro-soluble component is coated with hardened palm oil, preferably microlayers of hardened palm oil.

In another embodiment, the hydro-soluble component is coated with ethylcellulose and plasticizer. Preferably the plasticizer is selected from acetic acid esters of mono- and di- glycerides of fatty acids.

In another embodiment, the hydro-soluble component is coated (entrapped) inside alginate beads which are further incorporated inside solid lipid beads.

As used herein, the term ‘coated’ may refer to covering the surface of the hydro-soluble component with a coating substance. Preferably substantially all of the surface area of the hydro-soluble component is coated. More preferably, all of the surface area of the hydro-soluble component is coated.

In one embodiment, the term ‘coated’ may refer to covering, encapsulation, suspension or entrapment of the hydro-soluble component with/within the coating substance.

In one embodiment, the hydro-soluble component is covered with the coating substance, preferably completely covered.

In another embodiment, the hydro-soluble component is suspended in the coating substance.

In another embodiment, the hydro-soluble component is entrapped in the coating substance.

In another embodiment, the hydro-soluble component is encapsulated in the coating substance.

Composition

In another aspect, the present invention relates to a composition comprising a hydro-soluble component coated with a coating substance wherein the coating substance comprises of microlayers of a lipid. The coating itself is composed of multiple layers. Each layer is not continuous, but they overlap, thus building up a micro-layered structure (layers approximately 1 μm or less) analogous to a brick wall. This overlapping, layered structure creates a tortuous path for the water to diffuse along, thus greatly reducing the solubility rate of the coated composition.

As used herein, “microlayers” refers to layers of coating material under about one micron thick. Preferably, a multitude of microlayers are provided.

In one embodiment, the coating itself is composed of multiple microlayers each of which is not continuous around the hydro-soluble component, but each layer overlaps to completely cover the hydro-soluble component.

The presence of microlayers can be determined by techniques known to those skilled in the art. For instance scanning electron microscopy (SEM) can be used to visualise the layers. This technique would be familiar to the skilled person and involves freezing a sample in liquid nitrogen and fracturing the particles to reveal the interior structure of the coating. An alternative technique is oil-immersion microscopy.

Microlayers in the coating may be provided by hot melt coating the hydro-soluble component with a fat. Hot melt coating is a technique familiar to the skilled person further details of which can be found in “Single-Core Encapsulation: Film Coating” Chapter 5, Charles R. Frey and Harlan S. Hall, pages 83 -101 in Microencapsulation of Food Ingredients, Ed. Per Vilstrup, 2001 Leatherhead Publishing, LFRA Ltd and “Fluidized bed coating in food technology”, K. Dewettinck* and A. Huyghebaert, Trends in Food Science & Technology 10 (1999) pages 163-168.

In another aspect, the present invention relates to a composition comprising a coated hydro-soluble component obtainable by a process comprising hot melt coating a hydro-soluble component with a fat.

Preferably, the fat referred to above is as previously defined.

In another aspect, the present invention relates to a composition comprising a hydro-soluble component coated with a coating substance wherein the hydro-soluble component and the coating substance form a core, and wherein the core is coated with a further coating substance.

The further coating substance may or may not the same as the coating substance which coats the hydro-soluble component.

In one embodiment, the further coating substance is the same as the coating substance which coats the hydro-soluble component.

In another embodiment, the further coating substance and the coating substance which coats the hydro-soluble component may be independently selected from the coating substances previously defined herein.

Process for Preparation

In another aspect, the present invention relates to a process for the preparation of a composition as defined above, said process comprising coating a hydro-soluble component as defined above with a coating substance as defined above.

In one embodiment, coating is achieved by at least one of a hot melt coating, a spray-cooling or a hot melt extrusion process step.

In one embodiment, coating is achieved by two process steps selected from hot melt coating, spray-cooling or hot melt extrusion.

In one embodiment, coating is achieved by a combination of hot melt coating and spray-cooling, Preferably, coating is achieved by first spray-cooling the hydrosoluble component with a coating substance as defined above followed by hot melting coating the resultant material using a fluid bed.

Aquaculture

Aquaculture involves cultivating aquatic populations (e.g., freshwater and saltwater organisms) under controlled conditions. Organisms grown in aquaculture may include fish and crustaceans. Crustaceans are, for example, lobsters, crabs, shrimp, prawns and crayfish. The farming of finfish is the most common form of aquaculture. It involves raising fish commercially in tanks, ponds, cages or ocean enclosures, usually for food. A facility that releases juvenile fish into the wild for recreational fishing or to supplement a species' natural numbers is generally referred to as a fish hatchery. Particularly of interest are fish of the salmonid group, for example, cherry salmon (Oncorhynchus masou), Chinook salmon (Oncorhynchus tshawytscha), chum salmon (Oncorhynchus keta), coho salmon (Oncorhynchus kisutch), pink salmon (Oncorhynchus gorbuscha), sockeye salmon (Oncorhynchus nerka) and Atlantic salmon (Salmo salar), and various trout. Other finfish of interest for aquaculture include, but are not limited to, whitefish such as tilapia (including various species of Oreochromis, Sarotherodon, and Tilapia), grouper (subfamily Epinephelinae), sea bass, catfish (order Siluriformes, genus Pangasus), bigeye tuna (Thunnus obesus), carp (family Cyprinidae) and cod (genus Gadus).

Aquafeed

As used herein, the term ‘aquafeed’ has the normal meaning attributed to it in the art. For instance, an aquafeed may be considered as a manufactured or artificial diet (i.e., formulated feeds) to supplement or to replace natural feeds in the aquaculture industry. These prepared foods are most commonly produced in flake, pellet or tablet form. Typically, an aquafeed refers to artificially compounded feeds that are useful for farmed fish and crustaceans (i.e., both lower-value staple food fish species [e.g., freshwater fish such as carp, tilapia and catfish] and higher-value cash crop species for luxury or niche markets [e.g., mainly marine and diadromous species such as shrimp, salmon, trout, yellowtail, seabass, seabream and grouper]). These formulated feeds are composed of several ingredients in various proportions complementing each other to form a nutritionally complete diet for the aquacultured species.

Aquafeeds are composed of micro and macro components. In general, all components, which are used at levels of more than 1%, are considered as macro components. Feed ingredients used at levels of less than 1% are micro components. Both macro and micro ingredients are subdivided into components with nutritional functions and technical functions. Components with technical functions improve the physical quality of the aquaculture feed composition or its appearance.

Macro components with nutritional functions provide aquatic animals with protein and energy required for growth and performance. Wth respect to fish, the aquafeed should ideally provide the fish with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal, cotton seed meal), are also often included in the feed compositions, although carbohydrates are not a superior energy source for fish over protein or fat.

Fats are typically provided via incorporation of fish meals (which contain a minor amount of fish oil) and fish oils into the aquaculture feed compositions. Extracted oils that may be used in aquafeeds include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of most aquaculture products. A typical aquafeed will comprise from about 15-30% of oil (e.g., fish, vegetable, etc.), measured as a weight percent of the aquaculture feed composition.

In another aspect, the present invention relates to an aquafeed comprising a composition as described herein.

In one embodiment, the hydro-soluble component of the present invention is present in the aquafeed in a concentration of at least about 0.1% w/w.

In another embodiment, the hydro-soluble component is present in the aquafeed in a concentration of between about 0.1 and about 1.0% w/w, preferably about 0.2 and about 1.0% w/w.

In another embodiment, the hydro-soluble component is present in the aquafeed in a concentration of about 0.2, 0.5 or 1.0% w/w.

Preferably, the hydro-soluble component is as defined above.

In one embodiment, the aquafeed is provided as pellets and is suitable for feeding shrimp.

In another embodiment, the aquafeed is provided as flakes and is suitable for feeding fish.

In another embodiment, the aquafeed is provided as tablets.

In another aspect, the present invention relates to a process for preparation of an aquafeed as defined above.

In one embodiment, the aquafeed is prepared by (i) mixing a composition as defined above with other suitable feed ingredients (as described above), (ii) homogenising the mixture and (iii) processing the homogenised mixture into a suitable form.

In one embodiment, in step (iii), the homogenised mixture is pelletized into a form suitable for feeding shrimp e.g. a sinking pellet.

In another embodiment, in step (iii), the homogenised mixture is extruded into flakes and is suitable for feeding fish.

In another embodiment, in step (iii), the homogenised mixture is provided as tablets.

### EXAMPLES

Preparation of hydro-soluble coated component

### Preparative Example 1

This sample was prepared by spray-drying betaine with hydroxypropylmethyl cellulose (Methocel SGA7C) and an inert filler. Without being bound by theory, HPMC gels in aqueous solution which is believed to reduce diffusion of the betaine through the particle matrix; Methocel SGA7C gels between 30-45° C. The inclusion of an inert filler aims to reduce the payload of the sample and thus reduce the rate of diffusion of betaine.

0,25 kg of HPMC (Methocel SGA150; Dow Chemical Company) was dry-blended with 0,5 kg of betaine (Betafin BT; Finn Feeds) and dispersed in 5 kg cold tap water, using a Silverson homogenizer. 0,4 kg of further Betafin BT and 0,5 kg of Calcium Hydrogen Phosphate, Dihydrate (Chemische Fabrik Budenheim KG) was added to the solution with constant agitation. The suspension was fed to into a Niro 6,3 spray tower under the following conditions:

| Parameter | Setting |
|---|---|
| Atomising Device | Wheel |
| Rotation Speed (rpm) | 8000-10000 |
| Drying inlet air temperature (° C.) | 210-230 |
| Drying outlet air temperature (° C.) | 90-110 |
| Drying air flow (m³hr⁻¹) | 450-550 |

### Preparative Example 2 (Samples 4 and 5)

This sample was prepared by hot-melt coating with fully hardened palm oil.

1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3,2 mm electrically traced silicone hose. The coating material, fully hardened palm oil, was held at an elevated temperature (110° C.) in an oil-bath. 1,235 kg coating material was atomized onto the fluidized Betafin BT particles under the following conditions:

| Parameter | Setting |
|---|---|
| Bed temperature (° C.) | 44-46 |
| Inlet Air temperature (° C.) | 40-50 |
| Air flow rate (m³hr⁻¹) | 80-90 |
| Melt temperature (° C.) | 110 |
| Atomising Air pressure (bar) | 1.6-2.0 |
| Coating rate (kghr⁻¹) | 1.0 |

The finished product was sieved through 1500pm sieve to remove aggregates.

### Preparative Example 3 (Samples 6 and 7)

This sample was prepared by a combination of hot-melt extrusion and milling. The matrix was a mixture of ethylcellulose and Acetem (as plasticizer). Ethylcellulose is insoluble in water and was used to provide the scaffold of the particles, with the incorporated betaine providing the erodible content.

1 kg of Acetem 70-00 (DuPont) was heated to 60° C. and plated onto 4 kg ethylcellulose (Ethocel Standard 7 Premium; Dow Chemical Company) in a bowl chopper to create a homogenenous coating blend. Betaine (Betafin BT; Finn Feeds) was milled in a Retsch SK Rotor Mill (plate 15). The coating blend and Betafin BT were fed individually into the Clextral BC 45 co-rotating twin-screw extruder, using screw feeders with feed-rates of both streams varying from 4-5 kg/hr. The extruder was equipped with a 0,8 mm die plate. Temperature across the extruder was held constant at 150° C., except for the die plate, which was held at 90° C. Under production, pressure at the die plate varied from 20-40bar. The extrudate was collected on a conveyor belt, cooled and then milled (Restch SK 100 Rotor Mill, plate 15) to produce the finished product.

### Preparative Example 4 (Samples 8 and 9)

This sample was prepared by spray-cooling betaine with a suitable lipid followed by a second coating in a fluid bed.

2 kg of betaine (Betafin BT; Finn Feeds) was milled through a Retsch SK100 rotor mill (Plate 15) and added to 3 kg of fully hydrogenated rapeseed oil, held at 90-110° C. and homogenized at high speed with a Silverson mixer. The slurry was atomized into a Niro 6,3 spray tower under the following conditions:

| Parameter | Setting |
|---|---|
| Atomising Device | Wheel |
| Rotation Speed (rpm) | 5500-6500 |
| Cooling air temperature (° C.) | 5-15 |
| Cooling air flow (m³hr⁻¹) | 500-600 |
| Feed temperature (° C.) | 70-80 |

The finished intermediate was sieved through a 1000pm sieve to remove aggregates.

1.6 kg of the finished intermediate from above (fraction 125-500 μm) was fluidized in a GEA Aeromatic MP1 fluid bed, operating in top-spray mode. The bed was equipped with a Schlick series 970 nozzle connected to a Watson Marlow pump by 3,2 mm electrically traced silicone hose. The coating material, fully hardened rapeseed oil, was held at an elevated temperature in an oil-bath. 0,4 kg of coating material was atomized onto the fluidized intermediate particles under the following conditions:

| Parameter | Setting |
|---|---|
| Bed temperature (° C.) | 53-57 |
| Inlet Air temperature (° C.) | 55-70 |
| Air flow rate (m³hr⁻¹) | 45-70 |
| Melt temperature (° C.) | 120-140 |
| Atomising Air pressure (bar) | 1.4-2.0 |
| Coating rate (kghr⁻¹) | 0.4-0.8 |

The finished product was sieved through 1500pm sieve to remove aggregates.

### Preparative Example 5

This sample was prepared by spraying an aqueous film coating onto betaine in a fluid bed. A coating solution was prepared contained 300 g of a high molecular weight polyvinylalcohol (Mowial 18-88 from Kuraray), 140 g talc (Imerys Talc) and 25 g of lecithin (Solec CST 35 from DuPont, dissolved in 25 g of ethanol). The coating solution was further diluted with 500 g of cold water, maintained at ambient temperature and stirred constantly during spraying. 1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3,2 mm silicone hose. 1,397 g of coating solution was atomised onto the Betafin BT under the following conditions:

| Parameter | Setting |
|---|---|
| Bed temperature (° C.) | 46-49 |
| Inlet Air temperature (° C.) | 50-59 |
| Air flow rate (m³hr⁻¹) | 70-100 |
| Coating temperature (° C.) | Ambient |
| Atomising Air pressure (bar) | 2.2 |
| Atomising Air temperature (° C.) | 25 |
| Coating rate (kghr⁻¹) | 0.25-0.45 |

500 g in-process samples were removed at coating amounts equivalent to 5% and 10% coating. The finished product was sieved through 1500pm sieve to remove aggregates.

### Preparative Example 6A and 68

These samples were prepared by spray-drying betaine with a fully hydrolysed polyvinylalcohol.

1,41 kg of Betafin BT was dissolved in 0,94 kg of deionized water. 0,25 kg of polyvinylalcohol (6A: Poval 4-98 from Kururay or 6B: Selvol 103 from Seksui) was slowly added to 0,94 kg/1,25 kg of deionized water and heated, under agitation to 95° C. for 15 minutes. The 60% betaine solution was added to the hot polyvinylalcohol solution to give a feed solution with solids content of 43-50% (of which 85% was Betafin BT and 15% was polyvinylalcohol). The feed solution was atomized into a NIRO NP 6.3 spray unit, using a spray wheel (120 mm diameter) with co-current airflow (600m³h(¹). Wheel speed was 14000-15000 rpm; inlet air temperature 196-203° C., feed rate 52-55 kghr⁻¹ and outlet air temperature 102-111° C. A fine brown powder was collect from the rotary cell with mass yields between 52% (Poval 4-98) and 89% (Selvol E103).

Preparation of an aquafeed

| Ingredients | % wt. |
|---|---|
| Fish meal | 4.00 |
| Squid liver meal | 0.00 |
| Corn gluten | 3.00 |
| Soybean de-hulled | 40.00 |
| Canola Meal | 10.00 |
| Wheat flour | 21.60 |
| Rice bran (dehulled) | 10.00 |
| Wheat gluten (pellet binder) | 3.00 |
| Fish oil | 2.00 |
| Soybean oil | 0.20 |
| Lecithin | 1.00 |
| vitamin and mineral premix | 2.00 |
| DCP | 3.10 |
| Choline chloride | 0.10 |
| Betaine | [Different forms and levels] |
| Total | 100.00 |

Betaine (coated or uncoated) was mixed well with the fine powder ingredients, such as flour, then this mixture was homogeneously mixed with the rest of the ingredients (see table above) in a Hobart mixer for at least 30 minutes.

All ingredients were homogenized with water for 15 min before pelleting with a Hobart pelletizer (USA, Model A200T; pellet diameter: 1-3 mm) and they were dried at 60° C. for 24 h. The diets were stored in the refrigerator at 4° C. until used.

The feed was formulated to contain 35% protein, 7% fat and 19 MJ gross energy/kg diet.

Release Testing Method

An aquafeed sample (30 g) was placed in a rotating basket and immersed in 500 ml of artificial seawater (pH 8,2), held at 30° C. 5 ml aliquots of sample were withdrawn at selected time-points (1, 3, 5, 10, 15, 30, 45, 60 and 90 minutes). The volume of dissolution media was held constant (500 ml) through the re-addition of 5 ml aliquots of fresh media (30° C.). These samples were filtered on 45pm, frozen and analysed by HPLC in Advanced Analysis.

Release Profiles

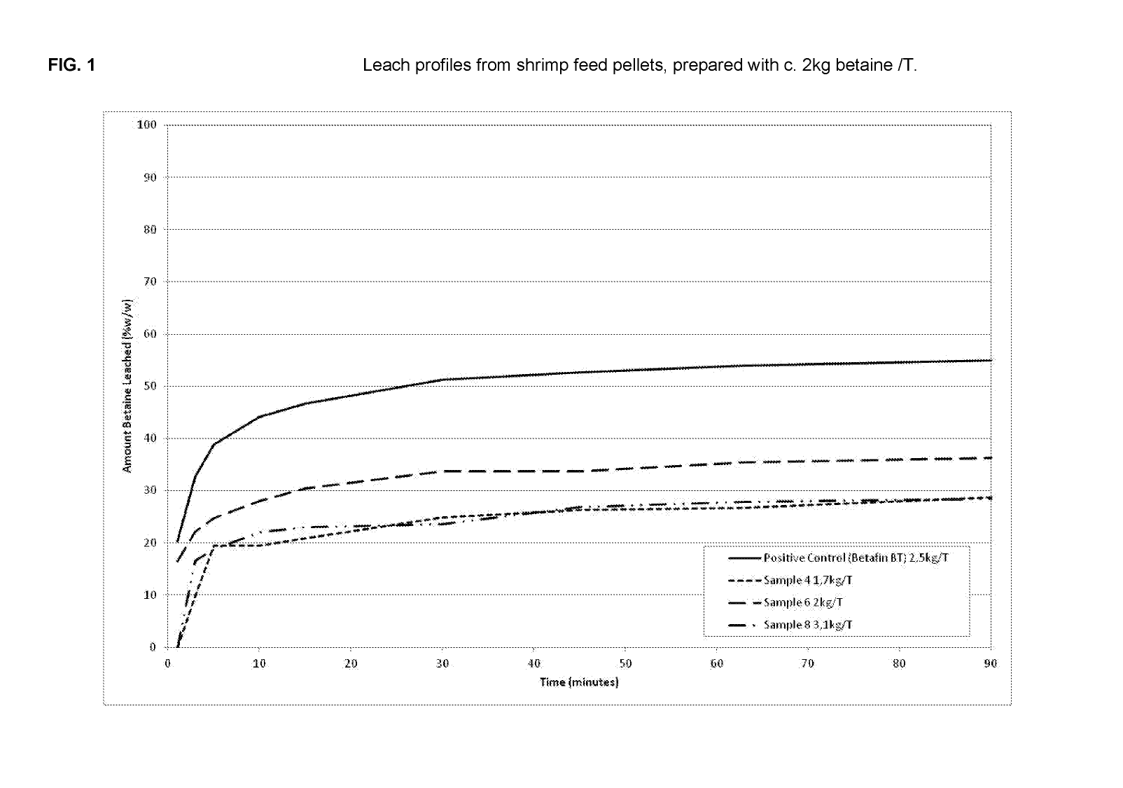

Release curves (see FIGS. 1 to 3) show the amount of betaine leached as a percentage of weight of available net betaine (% w/w).

Positive control samples (prepared with uncoated Betafin BT, (natural betaine)) are represented by the solid line. For all three pellet concentrations, the control samples show the fastest and most extensive leaching.

Leach profiles have been measured for the shrimp pellets prepared as above with either anhydrous betaine (Betafin BT (natural betaine) available from DuPont) or encapsulated betaine samples 4 to 9. Pellets have been prepared with net betaine contents of approximately 2 kg/T, 5 kg/T and 10 kg/T.

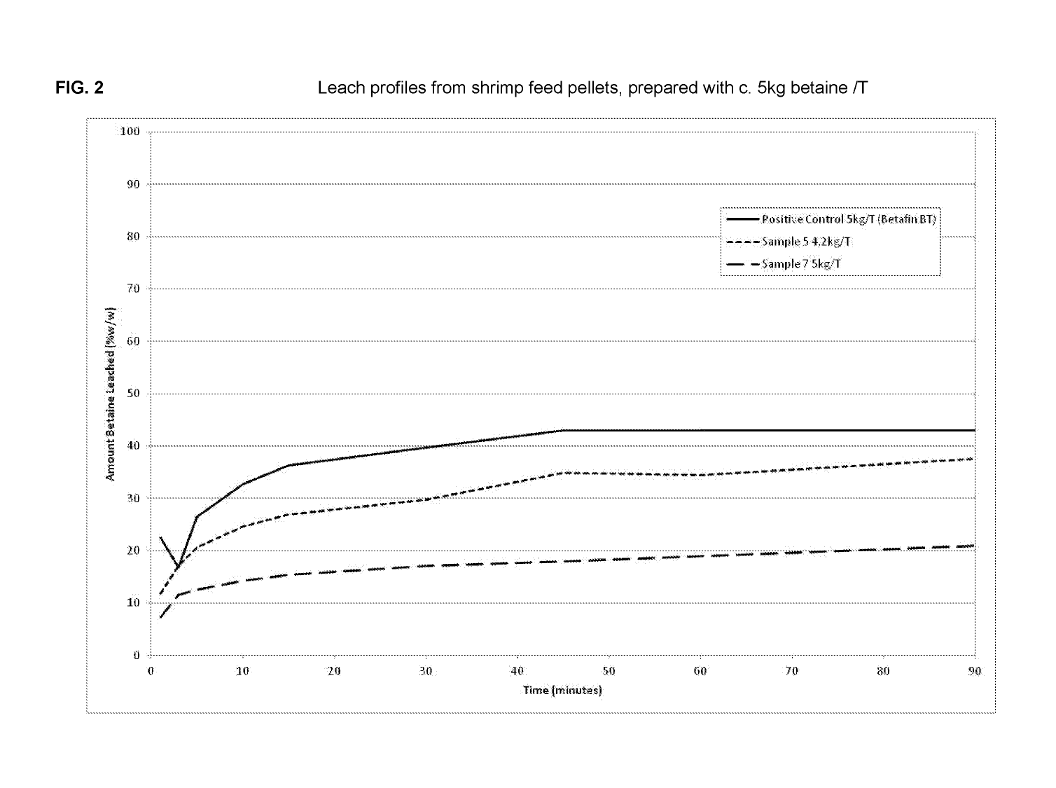

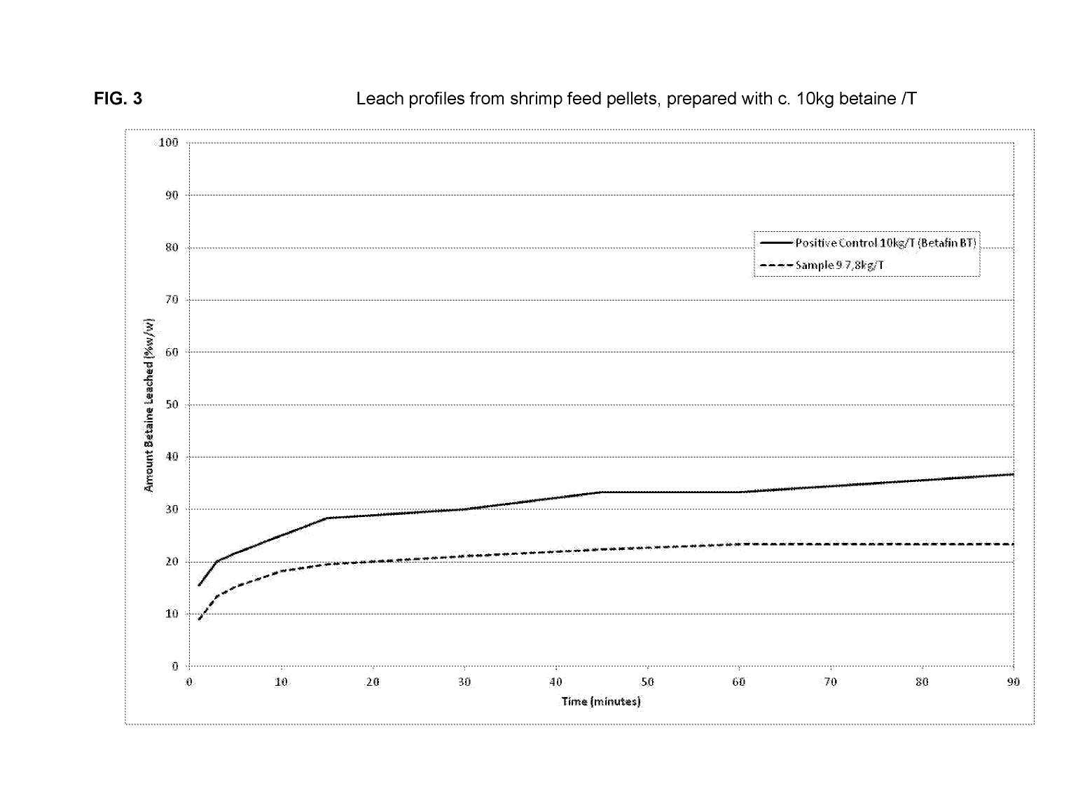

Results show (FIG. 1) that for the positive control samples, prepared with Betafin BT (natural betaine) a maximum of 60% of the available betaine is dissolved after 90 minutes (samples prepared with c. 2 kg/T). As the betaine content of the pellets increases, the proportion of betaine leached over 90 minutes decreases to 40% or below of the available betaine (FIGS. 2 and 3).

Leach profiles for pellets prepared with coated betaine are slower than for the positive control samples in all cases.

Pellets prepared with encapsulated samples 8 and 9 leach less betaine than those prepared with encapsulated samples 4 and 5, reflecting the double encapsulated nature of samples 8 and 9.

Sample Summary

| | Betaine | |
|---|---|---|
| Sample | Content (%) | Betaine Source |
| 1 | 0.25 | Betafin BT (natural betaine), |
| 2 | 0.5 | Positive Control |
| 3 | 1 | |
| 4 | 0.17 | Preparative example 2 |
| 5 | 0.42 | (Betaine in fully hardened palm oil) |
| 6 | 0.2 | Preparative example 3 |
| 7 | 0.5 | (Betaine in Ethylcellulose, Acetylated |
| | | monoglyceride) |
| 8 | 0.31 | Preparative example 4 |
| 9 | 0.78 | (Betaine in fully hardened rapeseed oil) |

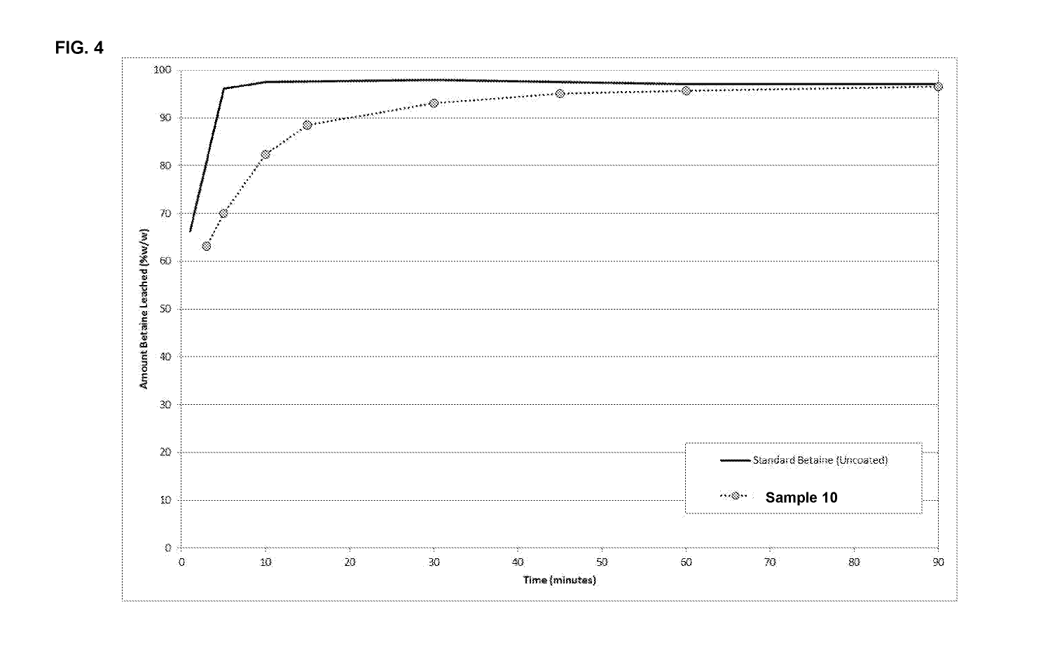

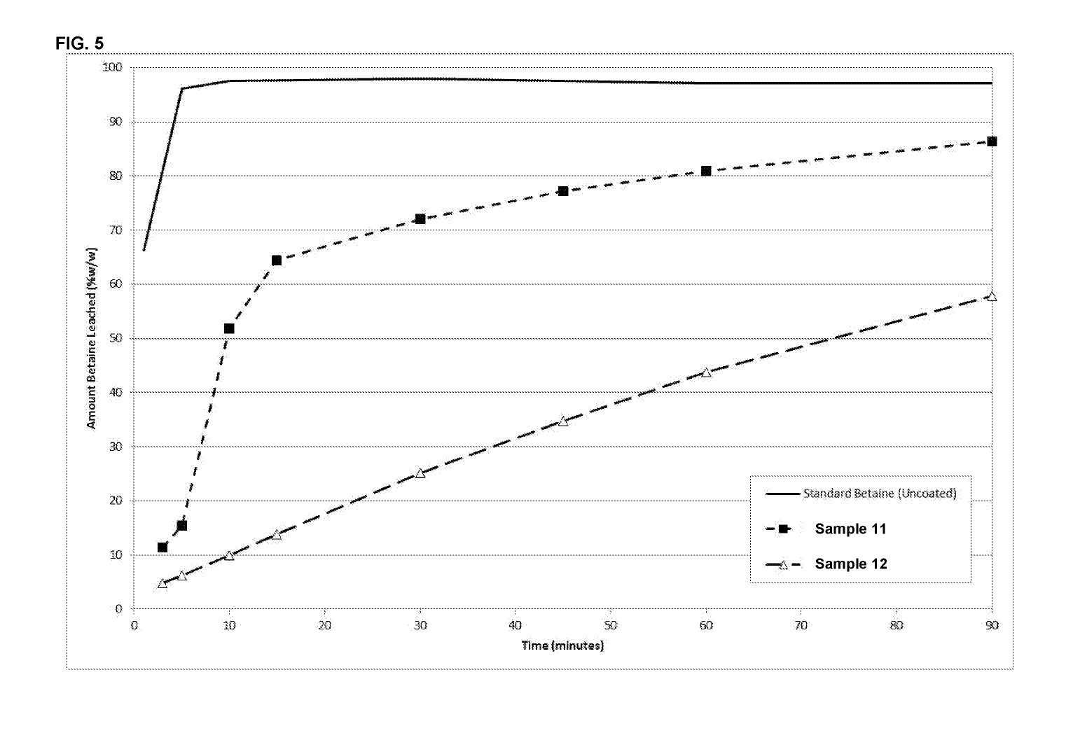

Release curves (FIGS. 4 and 5) show the amount of betaine leached from coated betaine samples, as a percentage of the weight of available net betaine (% w/w).

| | Betaine | |
|---|---|---|
| Sample | Content (%) | Betaine Source |
| 10 | 60 | Preparative example 5 (Betaine coated with |
| | | high molecular weight polyvinylalcohol) |
| 11 | 85 | Preparative example 6A (Betaine coated with |
| | | fully hydrolysed polyvinylalcohol) |
| 12 | 85 | Preparative example 6B (Betaine coated with |
| | | with fully hydrolysed polyvinylalcohol) |

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims appended hereto as permitted by applicable law.

1. A composition comprising a hydro-soluble component and a coating substance, wherein the hydro-soluble component is coated with the coating substance, wherein the coating substance reduces leaching of the hydro-soluble component from the composition when the composition is contacted with aqueous media.

2. The composition of claim 1 wherein the hydro-soluble component is selected from the group consisting of betaine, direct fed microbials, enzymes, essential oils, organic acids, vitamins, amino acids and minerals.

3. The composition of claim 1 or 2 wherein the hydro-soluble component comprises betaine or an animal feed acceptable salt or hydrate thereof.

4. The composition of claim 3 wherein the coating substance comprises a lipid, an emulsifier or a polymer.

5. The composition of claim 4 wherein the coating substance comprises a polymer selected from film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixtures thereof.

6. The composition of claim 4 wherein the coating substance comprises a lipid selected from animal oils or fats, vegetable oils or fats, triglycerides, vegetable waxes (such as carnauba, candelilla, bayberry or sugarcane), mineral waxes, synthetic waxes, natural and synthetic resins and mixtures thereof.

7. The composition of claim 6 wherein the coating substance comprises a hardened fat which has a melting point of about 40° C. to about 80° C.

8. The composition of claim 6 wherein the coating substance comprises a hardened fat which is a fully hardened fat.

9. The composition of claim 6 wherein the coating substance comprises a hardened fat which is comprised of triglycerides.

10. The composition claim 6 wherein the coating substance comprises a hardened fat which is comprised of triglycerides having a C14, C16 and C18 fatty acid chain length, and mixtures thereof.

11. The composition of claim 8 wherein the coating substance comprises a hardened fat selected from fully hardened canola oil, fully hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil and fully hardened rapeseed oil.

12. The composition of claim 6 wherein the coating substance is selected from ethylcellulose, HMPC, alginate, fully hardened palm oil, fully hardened rapeseed oil, fully hardened cottonseed oil and fully hardened soybean oil.

13. The composition of claim 5 wherein the coating substance comprises a polymer which is a polyvinylalcohol.

14. The composition of claim 1 or 4-13 wherein the coating substance comprises microlayers.

15. The composition of claim 3 wherein the animal feed and the coating substance form a core, and wherein the core is coated with a further coating substance.

16. (canceled)

17. (canceled)

18. A method for reducing leaching of a hydro-soluble component from a the composition when said composition is contacted with aqueous media, said method comprising coating a hydro-soluble component with a coating substance, wherein said coating substance reduces leaching of the hydro-soluble component from the composition when the composition is contacted with aqueous media.

19. The method of claim 18 wherein said method comprises coating a hydro-soluble component with a coating substance.

20. The method of claim 17 wherein the hydro-soluble component comprises betaine.

21. A composition comprising a hydro-soluble component coated with a coating substance wherein the coating substance comprises microlayers of a hardened fat.

22. A composition comprising a coated hydro-soluble component obtainable by a process comprising hot melt coating a hydro-soluble component with a hardened fat.

23. An aquafeed comprising the composition of claim 1 or 4-13, 19 or 20.

24. An aquafeed according to claim 21 wherein the aquafeed is provided as pellets.

23. An aquafeed according to claim 21 wherein the aquafeed is provided as flakes.
